(19) United States
(12) Patent Application Publication
(10) Pub. No.: US 2002/0173324 A1
(43) Pub. Date: Nov. 21, 2002

(54) Method for protocol-specific information management for wireless devices

(76) Inventor: Huba Horompoly, Redwood City, CA (US)

Correspondence Address: Randy Meritt, 1116 Fairview Ave., San Jose, CA, 95125, US

(21) Appl. No.: 10/143,608

(22) Filed: May 10, 2002

Related U.S. Application Data
(60) Provisional application No. 60/291,898, filed on May 18, 2001.

(51) Int. Cl. H04Q 7/00

(52) U.S. Cl. 455/517; 455/500

(57) ABSTRACT

A method for handling bi-directional data traffic between various information systems and any remote device over a wireless communication network is provided. Origination data may undergo reformatting for proper display with a hand-held wireless device. Data requests originating from a wireless device are handled asynchronously where the request may be in any format. A device identification is included that can be used to qualify data requests and data reception to specific types of wireless devices.

### BACKGROUND OF THE INVENTION

1. Field of the Invention

This application is related to commonly assigned, co-pending application entitled System And Method For Dynamic Access Of Information Over A Wireless Network filed on the same date as the present application by the same inventor.

The present invention relates generally to systems for transmitting two-way (bi-directional) messages between backend information systems, such as Enterprise Resource Planning (ERP) or Customer Relationship Management (CRM) systems, and front-end mobile devices or computers using wireless communication networks. Many of these backend data systems were originally developed with input/output destined for large capacity, direct-attached output media such as video display terminals or printers. With the advent of wireless networks, and small handheld computing devices designed to interface to wireless networks, there is a need to facilitate the retrieval of information from backend systems and to tailor such retrievals to the capability of these wireless devices. One technique for such services is the object of the present invention.

### OBJECTS OF THE PRESENT INVENTION

It is therefore an object of the present invention to provide a method for dynamically reformatting origination data destined for a remote device of small physical stature with limited display capacity.

It is a further object of the present invention to provide a method of handling asynchronous information requests originating from a device of small physical stature to a destination computing means where the requests can be in any format.

It is still a further object of the present invention to provide a method of multiple instances of the device service management function to support the same device protocol.

It is yet a further object of the present invention to provide a method of the device service function to support a device type identification that is used to identify characteristics unique to a device of small physical stature and base reception of information requests on such characteristics.

It is a further object of the present invention to provide a method of the device service function to support an identification method that is used to identify characteristics along organizational structures and base reception of information requests on such characteristics.

### SUMMARY OF THE INVENTION

A preferred embodiment of the present invention comprises a method for handling bi-directional data traffic between various information systems and any remote device over a wireless communication network, where the message may undergo formatting suitable for proper display with a hand-held wireless device. Traditional back-end information systems have typically been developed with output devices having fairly large capacity display areas, such as video display terminals or printers. The advent of hand-held devices used for remote access over wireless communication networks has surfaced the need for a method of coordinating the flow and reformatting the presentation of such back-end information sources to the more limited viewing capacity of wireless hand-held devices.

The present invention embodies a method of controlling asynchronously both requests for data as well as the reception of data to a hand-held device. The present invention also includes a method for end-users to specify alternate devices to send information back to as well as restricting the reception of information to a wireless device on the basis of either the type of device used or along organizational lines.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic view of interconnected subsystems capable of embodying the method of the present invention.

### DESCRIPTION OF THE PREFERRED EMBODIMENTS

The following description is provided to enable any person skilled in the art to make and use the invention and sets forth the best modes presently contemplated by the inventors of carrying out their invention. Various modifications, however, will remain readily apparent to those skilled in the art, since the generic principles of the present invention have been defined herein.

The present invention, hereinafter referred to as Device Server, is a wireless device service technology, which is capable of managing communication between a wireless device and a user session employing the device. Device Server is responsible for servicing devices that use a specific device protocol. For each device protocol there is a distinct Device Server. For scalability, however, the present invention allows for multiple instances of Device Server to be able to service a particular device protocol.

Device Server has two major components—handle an incoming request from a device and handle an outgoing request from a back-end information system to a device. The intercommunication between the back-end system and the Device Server is done through two queues: the Device Request Queue which handles inbound messages originating from a device, and the System Request Queue which handles outbound messages originating from a back-end system. The communicating parties are retrieving the messages for themselves from the appropriate queue and placing their responses back in the same queue.

Multiple Device Server instances can be installed for the same device protocol. Typically each organization can have their own set of Device Servers for specific device protocols they wish to service. Device Server optionally has device type and/or organization restrictions. With such optional restrictions Device Server will honor requests only on behalf of the specified device types and/or organizations.

Both incoming requests from a device and outgoing requests destined to a device utilize queues to hold requests formatted according to a message structure specification. A Device Queue Manager within the present invention is responsible for receiving and forwarding the messages between the Device Server and a user session. This queue manager receives a device request from the Device Server in any format and forwards the request to a user session. In the reverse direction, the Device Queue Manager receives system requests from a user session and forwards them to the appropriate Device Server.

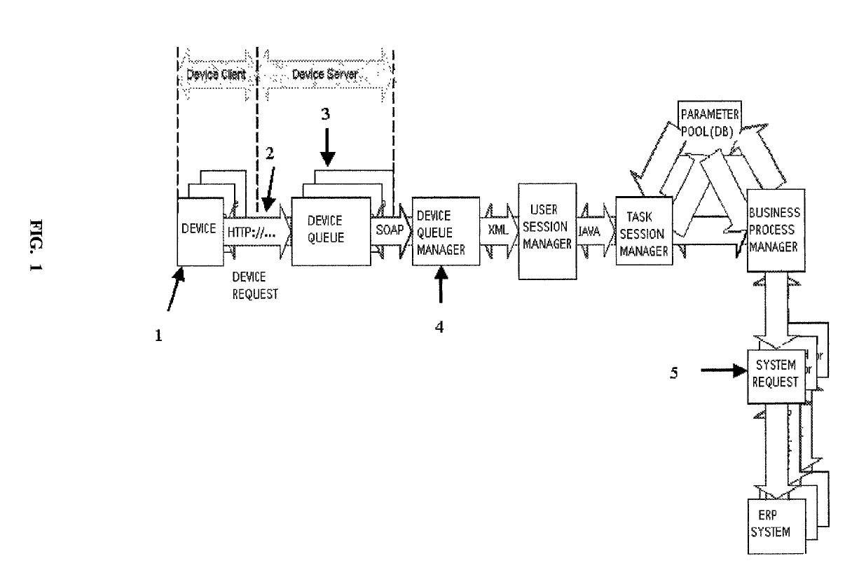

Referring to FIG. 1, in the scenario of a request from a device to the system, the user initiates a request on a device, shown generally at 1. The device passes information to the Device Server shown at 2. The Device Server converts the input to a format according to a preset specification and places it into a device request queue at 3. The Device Server then calls a Device Queue Manager shown at 4 passing a reference to the just inserted request entry and waits for a response.

The Device Queue Manager stores the request and calls the User Session Manager passing the request along and also waits for a response. The user session manager converts the request into a native structure and authenticates the request. An invalid request returns an error response. A valid request is directed to an appropriate object for handling. If the request is for the execution of a task then the request is forwarded to a Task Manager and the request awaits completion of the associated task.

When the response arrives from the Task Manager to the user session manager, it stores the response for logging and retrieving. Then depending on the device type returns either the entire response or a first portion of the response in any application independent format, such as through a public API, XML, or other standard data format, with instructions on how to retrieve the rest of the response to the Device Queue Manager. The Device Queue Manager, generally shown at 4, stores the response in the queue shown at 3 and then returns it back to the Device Server at 2.

The Device Server extracts the data from the response structure, reformats it and returns one or more screens to the device shown at 1. When the Device Server completes the communication with the device it calls the Device Queue Manager indicating that the response was displayed on the device. Device Queue Manager marks the system response delivered and purges and/or just logs the message.

Referring again to FIG. 1, in the case of outgoing requests the Device Server provides a System Request Handler shown generally at 5 that can be called by the backend information system when it wishes to push, or send, information to a device.

In the scenario of a system-initiated request to a device, the system places its request into a queue of the System Request Handler shown at 5. A backend push process initiates a Device Server specific method and this method starts to asynchronously handle the request. The method instance at this point idles, waiting for the Device Server to communicate with the device. When the device has returned its response, the Device Server places it into the Device Request Queue, calls User Session Manager, and returns a response to the device and marks the message as delivered.

Device Interaction Session holds data on a single interaction between the Device Server and a user session and is kept by the user session manager. There may be occasions, such as in handling certain classes of devices, where a single interaction must be broken to several pieces. For example, Wireless Access Protocol (WAP) phones are limited in memory. Transmitting large outputs may take multiple interactions to download from a server. In these cases the user session manager will keep the data on the server until all data is sent.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method for controlling access to and manipulation of electronic information comprising:
a plurality of interconnected computing devices each capable of interfacing to both wireless and land-based communication networks with each computing device including at least a processor and local storage;
a subset of stated interconnected computing devices comprising devices of small physical stature tailored for use with a wireless network;
a subset of stated interconnected computing devices comprising computing systems that contain data desired to be received by the devices of small physical stature;
a method for managing asynchronous information requests originating from a computing means containing source data to be scheduled for transmission to a device of small physical stature where the source data may undergo reformatting specific to the physical characteristics of the device of small physical stature;

2. The method of claim 1 further comprising:
a method of handling asynchronous information requests originating from a device of small physical stature to a destination computing means where the request can be in any format;

3. The method of claim 1 further comprising:
a method of controlling multiple instances of the device service function where the multiple device service instances can support the same device protocol;

4. The method of claim 1 further comprising:
a method of the device service capability that supports a device-type identification, which is used to identify characteristics unique to a device of small physical stature and base the format of the requested information on such characteristics;

5. The method of claim 1 further comprising:
the capability of the device service management function to support an identification method that is used to identify characteristics along organizational structures and base reception of information requests based on such characteristics.
